(19) United States
(12) Patent Application Publication
(10) Pub. No.: US 2024/0406108 A1
(43) Pub. Date: Dec. 5, 2024

(54) PRIVATE VIRTUAL LOCAL AREA NETWORK (VLAN) ON PROGRAMMABLE DEVICES

(71) Applicant: Arista Networks, Inc., Santa Clara, CA (US)

(72) Inventors: Basil Saji, Bangalore (IN); Vishal Bandekar, Bangalore (IN); Milind Kulkarni, Bangalore (IN); Anirudh Singh, Bangalore (IN); Vishnu Vardhan K, Bangalore (IN)

(21) Appl. No.: 18/325,757

(22) Filed: May 30, 2023

(51) Int. Cl. H04L 45/76; H04L 45/745

(52) U.S. Cl. CPC H04L 45/76; H04L 45/745

(57) ABSTRACT

A network device or a system can be used to implement a private virtual local area network (VLAN). Such network device or system can receive a packet via an ingress port, perform a VLAN mapping lookup to identify a private VLAN domain based on the ingress port and an ingress subdomain associated with a primary VLAN or a secondary VLAN in the private VLAN domain, set a forwarding domain of the packet to the private VLAN domain, store the ingress subdomain and optionally the private VLAN domain as metadata, perform learning and forwarding lookups using the private VLAN domain to identify the ingress port and an egress port for the packet, reset the forwarding domain of the packet back to the ingress subdomain by the end of the forwarding lookup, and perform VLAN filtering based on the ingress subdomain.

### BACKGROUND

A private virtual local area network (private VLAN or PVLAN) is a type of VLAN configured to provide an additional layer of security and isolation within a VLAN. A private VLAN can be implemented on one or more network devices. A private VLAN can include a primary VLAN and one or more secondary VLANs.

A network device can include a packet processing pipeline having a series of stages. An incoming packet arriving at the network device can be part of a subdomain associated with the primary VLAN or one of the secondary VLANs. Conventionally, the series of stages in a packet processing pipeline perform operations using a forwarding domain that is set equal to the subdomain of the incoming packet. Setting the forwarding domain equal to the subdomain of the incoming packet in this way, however, does not satisfy the requirements associated with operating a private VLAN. It is within this context that the embodiments herein arise.

### BRIEF DESCRIPTION OF THE DRAWINGS

FIG. 1 is a diagram of an illustrative network device configured to route data packets in accordance with some embodiments.

FIG. 2 is a diagram of an illustrative network device configured to implement a private virtual local area network (PVLAN) in accordance with some embodiments.

FIG. 3 is a diagram of an illustrative packet processing pipeline that includes a VLAN mapping stage, a learning and forwarding stage, and a VLAN filtering stage in accordance with some embodiments.

FIG. 4 is a flow chart of illustrative steps for operating the packet processing pipeline shown in FIG. 3 in accordance with some embodiments.

FIG. 5 is a diagram showing illustrative hardware components within a data processing system in accordance with some embodiments.

### DETAILED DESCRIPTION

Private virtual local area network (VLAN) is a type of VLAN configured to save/share Internet Protocol (IP) subnets and to provide an additional layer of security and isolation within a VLAN. The private VLAN is identified by a private VLAN domain. A private VLAN divides a primary VLAN broadcast domain into multiple smaller secondary VLAN broadcast subdomains. The secondary VLANs can include one or more community VLANs and/or one or more isolated VLANs.

Private VLAN operation can have two requirements: (1) all MAC address learning and forwarding lookup operations for primary and corresponding secondary VLANs need to occur in the same forwarding domain; and (2) the VLAN filtering operation has to be based on the subdomain of the secondary VLAN. To accomplish this, an ingress packet arriving at an ingress port belonging to a primary or secondary VLAN can be examined to identify the corresponding private VLAN domain. A packet processing pipeline can include a VLAN mapping stage, one or more intermediate stages, a learning and forwarding stage, and a VLAN filtering stage. In the VLAN mapping stage, the forwarding domain can be set to the private VLAN domain while the subdomain of the secondary VLAN can be temporarily saved as metadata. The intermediate stages may perform one or more processing steps not related to private VLAN.

The learning and forwarding stage may perform learning lookup and forwarding lookup operations. The learning operation may be used to identify the ingress (source) port associated with the private VLAN domain and the source MAC address. The forwarding lookup operation may be used to identify an egress (destination) port associated with the private VLAN domain and the destination MAC address. Operated in this way, the learning and forwarding lookup operations for primary and corresponding secondary VLANs can occur in the same forwarding domain, thus satisfying the first (1) private VLAN requirement. Subsequently, the subdomain of the secondary VLAN can be retrieved from the metadata, and the forwarding domain can be reset to the ingress subdomain. Thereafter, VLAN filtering operations can be performed based on the ingress subdomain, thus satisfying the second (2) private VLAN requirement.

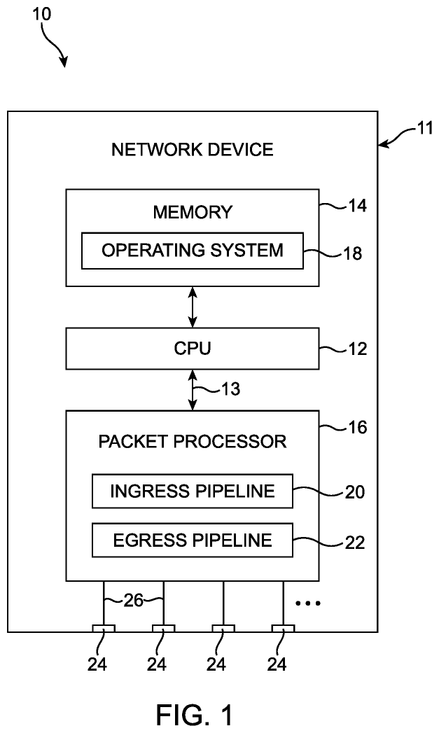

FIG. 1 is a diagram of a network device such as network device 10 that can be used to support a virtual local area network (VLAN) such as a private VLAN (or PVLAN). Network device 10 may be a router, a switch, a bridge, a hub, a repeater, a firewall, a device serving other networking functions, a network device that includes a combination of these functions, or other types of network elements. As shown in FIG. 1, network device 10 may include processing circuitry such as a central processing unit (CPU) 12, storage circuitry including memory 14, and a packet processing circuit such as packet processor 16 all disposed within a housing 11 of device 10. Housing 11 may be an exterior cover (e.g., a plastic exterior shell, a metal exterior shell, or an exterior shell formed from other rigid or semirigid materials) that provides structural support and protection for the components disposed within the housing. In general, processing unit 12 may represent processing circuitry based on one or more microprocessors, graphics processing units (GPUs), host processors, general-purpose processors, microcontrollers, digital signal processors, application-specific integrated circuits (ASICs), application-specific system processors (ASSPs), programmable logic devices such as field-programmable gate arrays (FPGAs), power management integrated circuits (PMICs), a combination of these processors, or other types of processors. Central processing unit 12 may sometimes be referred to herein as a main processor 12.

Processor 12 may be used to run a network device operating system such as operating system (OS) 18 and/or other software/firmware that is stored on memory 14. Memory 14 may include non-transitory (tangible) computer readable storage media that stores operating system 18 and/or any software code, sometimes referred to as program instructions, software, data, instructions, or code. Memory 14 may include nonvolatile memory (e.g., flash memory or other electrically-programmable read-only memory configured to form a solid-state drive), volatile memory (e.g., static or dynamic random-access memory), hard disk drive storage, and/or other storage circuitry. The processing circuitry and storage circuitry described above are sometimes referred to collectively as control circuitry. Processor 12 and memory 14 are sometimes referred to as being part of a “control plane” of network device 10.

Operating system 18 running in the control plane of network device 10 may exchange network topology information with other network devices using a routing protocol. Routing protocols are software mechanisms by which multiple network devices communicate and share information about the topology of the network and the capabilities of each network device. For example, network routing protocols executed on device 10 may include Border Gateway Protocol (BGP) or other distance vector routing protocols, Enhanced Interior Gateway Routing Protocol (EIGRP), Exterior Gateway Protocol (EGP), Routing Information Protocol (RIP), Open Shortest Path First (OSPF) protocol, Label Distribution Protocol (LDP), Multiprotocol Label Switching (MPLS), intermediate system to intermediate system (IS-IS) protocol, Protocol Independent Multicast (PIM), Virtual Routing Redundancy Protocol (VRRP), Hot Standby Router Protocol (HSRP), and/or other Internet routing protocols (just to name a few).

Processor 12 may be coupled to packet processor 16 via path 13. Control signals, data signals, and/or other types of signals can be conveyed between processors 12 and 16 via connection path 13. Packet processor 16 is oftentimes referred to as being part of a “data plane” or “forwarding plane.” Packet processor 16 may represent processing circuitry based on one or more network processing units, microprocessors, general-purpose processors, application specific integrated circuits (ASICs), programmable logic devices such as field-programmable gate arrays (FPGAs), a combination of these processors, or other types of processors. Packet processor 16 may be coupled to input-output ports 24 via paths 26 and receives and outputs data packets via input-output ports 24. Ports 24 that receive data packets from other network elements are sometimes referred to as ingress ports, whereas ports 24 through which packets exit out of device 10 towards other network elements are sometimes referred to as egress ports. Ports 24 are sometimes referred to collectively as ingress-egress ports.

Packet processor 16 can analyze the received data packets, process the data packets in accordance with a network protocol, and forward (or optionally drop) the data packets accordingly. Data packets received in the data plane may optionally be analyzed in the control plane to handle more complex signaling protocols. Memory 14 may include information about the speed(s) of input-output ports 24, information about any statically and/or dynamically programmed routes, any critical table(s) such as forwarding tables or forwarding information base (FIB), critical performance settings for packet processor 16, other forwarding data, and/other information that is needed for proper function of packet processor 16.

A data packet is generally a formatted unit of data conveyed over a network. Data packets conveyed over a network are sometimes referred to as network packets. A group of data packets intended for the same destination should have the same forwarding treatment. A data packet typically includes control information and user data (payload). The control information in a data packet can include information about the packet itself (e.g., the length of the packet and packet identifier number) and address information such as a source address and a destination address. The source address represents an Internet Protocol (IP) address that uniquely identifies the source device in the network from which a particular data packet originated. The destination address represents an IP address that uniquely identifies the destination device in the network at which a particular data packet is intended to arrive.

Data packets received in the data plane may optionally be analyzed in the control plane to handle more complex signaling protocols. Packet processor 16 may be configured to partition data packets received at an ingress port 24 into groups of packets based on their destination address and to choose a next hop device for each data packet when exiting an egress port 24. The choice of next hop device for each data packet may occur through a hashing process (as an example) over the packet header fields, the result of which is used to select from among a list of next hop devices in a routing table stored on memory in packet processor 16. Such a routing table listing the next hop devices for different data packets is sometimes referred to as a hardware forwarding table, a hardware forwarding information base (FIB), or a media access control (MAC) address table. The routing table may list actual next hop network devices that are currently programmed on network device 10 for each group of data packets having the same destination address. If desired, the routing table may also list actual next hop devices currently programmed for device 10 for multiple destination addresses (i.e., device 10 can store a single hardware forwarding table separately listing programmed next hop devices corresponding to different destination addresses). The example of FIG. 1 showing four ingress-egress ports 24 is merely illustrative. In general, packet processor 16 can be coupled to up to ten input-output ports 24, up to twenty input-output ports 24, up to thirty input-output ports 24, up to fifty input-output ports 24, up to a hundred input-output ports 24, or more than a hundred input-output ports 24.

Packet processing block 16 of FIG. 1 may generally represent one or more packet processors. Each packet processor 16 may include a packet processing pipeline that includes an ingress pipeline 20 and an egress pipeline 22. Each port 24 can have its own ingress pipeline 20 and its own egress pipeline 22. Data packets received at an ingress port 24 may be processed by an ingress pipeline 20 associated with that ingress port, whereas data packets transmitted from an egress port 24 may be processed using an egress pipeline 22 associated with that egress port. Ingress pipeline 20 may forward a data packet to egress pipeline 22 corresponding to a port 24 on which the packet will egress from device 10. Ingress pipeline 20 may include selection circuitry (sometimes referred to as a selector) configured to direct an intermediate data packet and associated metadata produced in the ingress pipeline to an appropriate egress pipeline 22. The selector within ingress pipeline 20 can select an egress pipeline 22 based on information contained in the received data packet.

In some embodiments, network device 10 can be based on a scalable architecture that includes multiple interconnected network chips where the packet processing functionality is distributed between separate ingress and egress pipelines. For example, ingress pipeline 20 and egress pipeline 22 can be implemented using separate logic circuitry. As another example, ingress pipeline 20 and egress pipeline 22 can be implemented as part of separate integrated circuit (IC) chips.

Ingress pipeline 20 can include a parser and a processing engine, sometimes referred to as an ingress parser and an ingress processing engine, respectively. Ingress pipeline 20 can use ingress lookup and editing tables (sometimes referred to as ingress data tables) to provide editing instructions based on the contents of an ingress data packet to drive the ingress processing engine. Generally, when a data packet is received on a port 24 of network device 10, the received data packet feeds into an ingress pipeline 20 associated with that port 24. The parser of that ingress pipeline 20 parses the received data packet to access portions of the data packet. The parsed information can be used as search/lookup keys into ingress data tables to produce metadata that is then used to identify a corresponding egress pipeline and to direct processing in the egress pipeline (e.g., to bridge or route the data packet, to selectively add a tunnel header, etc.).

In some instances, lookup operations can be performed using the ingress data tables to obtain editing instructions that feed into the processing engine to direct editing actions on the data packet. In other instances, the ingress packet might not be edited. In either scenario, the data packet output from an ingress pipeline can sometimes be referred to herein as an “intermediate packet.” The intermediate data packet and the metadata output from an ingress pipeline can be forwarded by its associated selector and queued towards an appropriate egress pipeline. In some embodiments, the selector can select the egress pipeline based on information contained in the metadata and/or information contained in the ingress data packet.

Egress pipeline 22 can include its own parser and processing engine. The egress pipeline can include a parser and a processing engine, sometimes referred to as an egress parser and an egress processing engine, respectively. The egress pipeline can access egress lookup and editing tables (sometimes referred to as egress data tables) to provide editing instructions to the egress processing engine. Generally, when the selector transmits the intermediate data packet from the ingress pipeline to the egress pipeline, the egress parser of the egress pipeline can parse the received intermediate packet to access portions of that packet. Various lookups can be performed on the egress data tables using the parsed data packet and the metadata to obtain appropriate editing instructions that feed into the egress processing engine. The editing instructions can direct actions performed by the egress processing engine to produce a corresponding egress data packet.

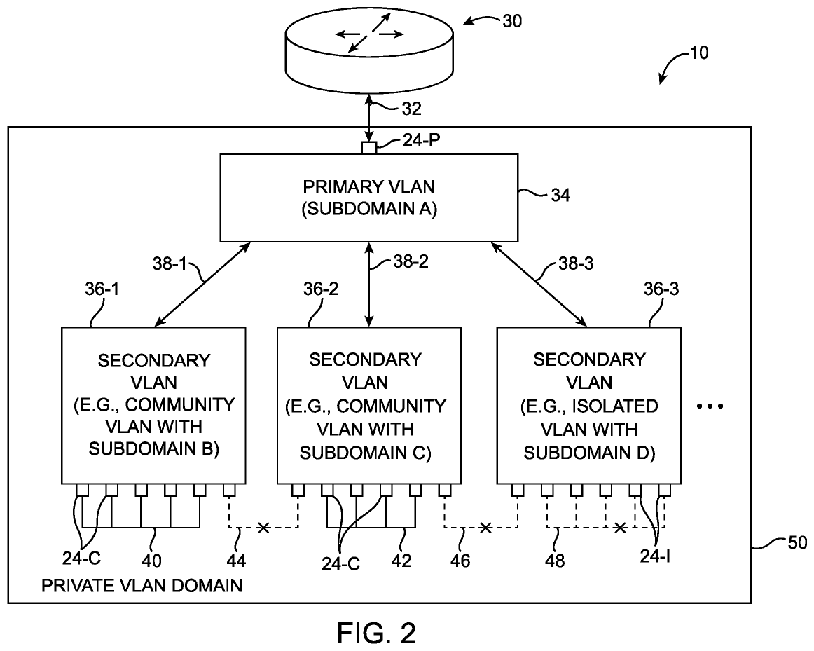

Network device 10 of the type described in connection with FIG. 1 can be used to implement a virtual local area network (VLAN) such as a private VLAN. FIG. 2 is a diagram of a private VLAN that can be implemented using device 10 in accordance with some embodiments. Private VLAN (or “PVLAN”) is a networking technology that allows the partitioning of a single VLAN into smaller VLANs for enhanced network security and management. As shown in FIG. 2, a private VLAN can be implemented using network device 10 and can include a primary VLAN such as primary VLAN 34 and one or more secondary VLANs 36.

Secondary VLANs can include one or more community VLANs and/or one or more isolated VLANs. In the example of FIG. 2, primary VLAN 34 may be coupled to a first secondary VLAN 36-1 (e.g., a first community VLAN) via communications path 38-1, may be coupled to a second secondary VLAN 36-2 (e.g., a second community VLAN) via communications path 38-2, and may be coupled to a third secondary VLAN 36-3 (e.g., an isolated VLAN) via communications path 38-3. The example of FIG. 2 in which primary VLAN 34 is operable to communicate with three secondary VLANs 36 is merely illustrative. In general, primary VLAN 34 may be coupled to two or more secondary VLANs, two to ten secondary VLANs, 10 to 20 secondary VLANs, 20 to 100 secondary VLANs, hundreds of secondary VLANs, or thousands of secondary VLANs.

The private VLAN of FIG. 2 can be identified by a private VLAN domain 50. The private VLAN domain of a private VLAN contains all the ports that are associated with the primary VLAN 34 and the secondary VLANs 36 within the private VLAN. The private VLAN domain can thus represent a logical grouping of ports within network device 10 or a network that shares the same private VLAN settings and/or policies. The primary VLAN 34 serves as the backbone of the private VLAN domain and may be responsible for forwarding of broadcast and multicast traffic within the private VLAN domain. The primary VLAN 34 can communicate with devices in any of the associated community VLANs (e.g., via paths 38-1 and 38-2) and with devices in any of the associated isolated VLANs (e.g., via path 38-3). The private VLAN domain can be partitioned into a single primary and a plurality of smaller secondary VLAN broadcast subdomains. Primary VLAN 34 may, for example, be associated with a subdomain A within the private VLAN domain. The subdomain of the primary VLAN 34 may sometimes be referred to or defined herein as a primary VLAN subdomain.

Primary VLAN 34 may also have one or more promiscuous ports operable to communicate with all other ports in the private VLAN domain. Promiscuous ports such as promiscuous port 24-P can be coupled to network devices such as router(s) 30 via path 32, firewalls, or other network elements that might need to communicate with all devices within the private VLAN. Promiscuous ports can be responsible for forwarding all traffic to and from the correct community or isolated VLAN port(s).

Community VLANs such as community VLANs 36-1 and 36-2 are secondary or sub VLANs coupled to the primary VLAN 34. Each community VLAN can be assigned a unique VLAN identifier (ID) and can include a group of ports that communicate with each other within the same community VLAN as well as with other ports in the primary VLAN 34. As shown in FIG. 2, first community VLAN 36-1 can include community ports such as community ports 24-C configured to communicate with all other ports in the same community VLAN (as shown by path 40) as well as with devices in the primary VLAN (as shown by path 38-1). As another example, second community VLAN 36-2 can include community ports 24-C configured to communicate with all other ports in the same community VLAN (as shown by path 42) as well as with devices in the primary VLAN (as shown by path 38-2). Devices in different community VLANs, however, should not communicate with any other secondary VLANs (as shown by broken path 44). Community VLANs are often used to group together devices that need to communicate with one another, such as different servers within a data center, different phones in a call center, or different devices within a large enterprise network. As an example, community VLAN 36-1 may be associated with a subdomain B within the private VLAN domain. As another example, community VLAN 36-2 may be associated with a subdomain C within the private VLAN domain. The subdomains of the community VLANs may sometimes be referred to or defined herein as community VLAN subdomains.

Isolated VLANs such as isolated VLAN 36-3 are secondary or sub VLANs coupled to the primary VLAN 34 but are isolated from all other VLANs within the private VLAN domain. Each isolated VLAN can be assigned a unique VLAN identifier (ID) and can include a single port or a group of ports that cannot communicate with any other ports within the isolated VLAN. As shown in FIG. 2, isolated VLAN 36-3 can include isolated ports such as isolated ports 24-I. Devices connected to the isolated ports 24-I can communicate only with devices in the primary VLAN 34 but cannot communicate with any other ports within the private VLAN domain. Devices coupled to separate isolated ports 24-I cannot communicate with each other (as shown by broken path 48). Devices coupled to an isolated port 24-I also cannot communicate with other secondary VLANs (as shown by exemplary broken path 46). Isolated VLANs are often used to isolate sensitive data or devices that require a high level of security, such as devices in a financial system, point-of-sale terminal, security camera, or devices used to store personal data. As an example, isolated VLAN 36-3 may be associated with a subdomain D within the private VLAN domain. The subdomain of the isolated VLAN may sometimes be referred to or defined herein as an isolated VLAN subdomain.

Private VLAN operation has at least two requirements: (1) all media access control (MAC) address learning and forwarding lookup operations for the primary and corresponding secondary VLANs has to occur in the same forwarding domain; and (2) a VLAN filtering operation has to be based on the subdomain associated with the ingress primary or secondary VLAN. The forwarding domain can be defined herein as a forwarding domain of a packet in which the learning and forwarding lookup operations occur in the packet processing pipeline.

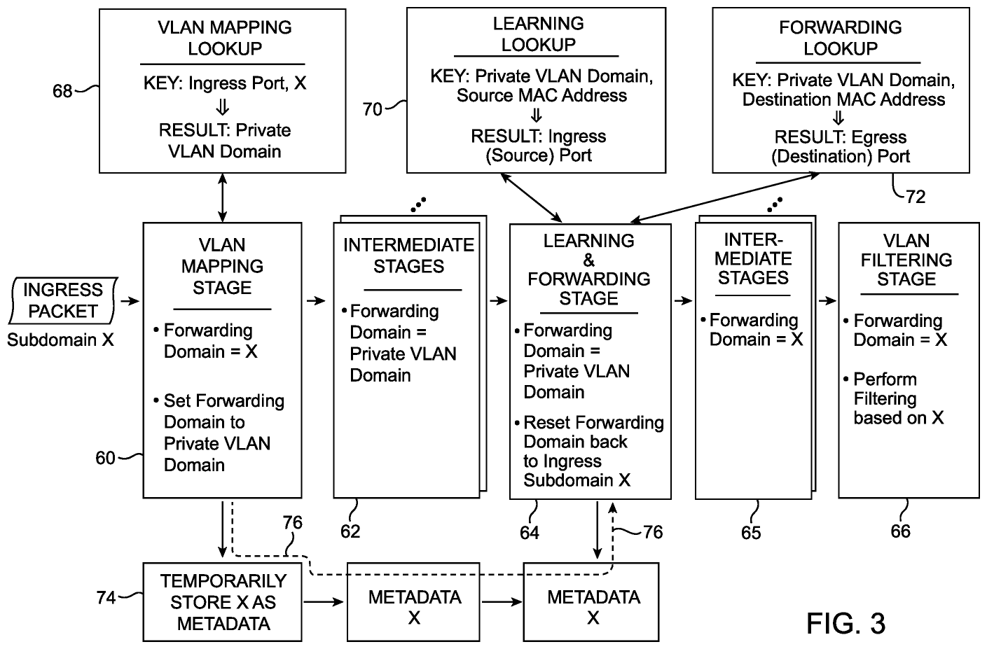

FIG. 3 is a diagram of an illustrative packet processing pipeline that includes a VLAN mapping stage such as VLAN mapping stage 60, a learning and forwarding stage such as learning and forwarding stage 64, and a VLAN filtering stage such as VLAN filtering stage 66 in accordance with some embodiments. One or more intermediate stages such as intermediate stage(s) 62 can be interposed between the VLAN mapping stage 60 and the learning and forwarding stage 64 in the packet processing pipeline. The learning and forwarding stage 64 and the VLAN mapping stage 60 can sometimes be considered to be part of the ingress pipeline (see ingress pipeline 20 of FIG. 1). The filtering stage 66 can sometimes be considered to be part of the egress pipeline (see egress pipeline 22 of FIG. 1). The one or more intermediate stages 62 can optionally be considered to be part of the ingress pipeline. One or more intermediate stages 65 can be interposed between learning and forwarding stage 64 and VLAN filtering stage 66 can optionally be considered to be part of the ingress pipeline and/or the egress pipeline.

As shown in FIG. 3, an incoming data packet (sometimes referred to as an ingress packet) can arrive at a particular ingress port and can have a subdomain X associated with the primary VLAN or one of the secondary VLANs. The term “ingress port” used herein can refer to any physical or logical port (interface) of device 10. This subdomain X of the ingress packet can sometimes be referred to and be defined herein as the “ingress subdomain.” As an example, the source port might be Ethernet-1, and the primary VLAN subdomain and the secondary VLAN subdomain of Ethernet-1 might be equal to exemplary values of 100 and 10, respectively. The ingress subdomain may be equal to 10 (e.g., X=10).

The ingress data packet may first be processed by the VLAN mapping stage 60. During the VLAN mapping stage 60, the forwarding domain of the data packet may initially be set to the ingress subdomain of the ingress packet (e.g., the forwarding domain may be set equal to 10). The VLAN mapping stage 60 may perform a VLAN mapping lookup operation such as VLAN mapping lookup 68. During the VLAN mapping lookup 68, the ingress port through which the data packet arrived and the ingress subdomain can be used as keys to identify the private VLAN domain of the private VLAN. For example, keys of Ethernet-1 and ingress subdomain X might return an exemplary private VLAN domain of 1000.

Once the private VLAN domain is identified by the mapping lookup, the forwarding domain of the data packet can be set or mapped to the identified private VLAN domain (e.g., the forwarding domain is modified to 1000). During the VLAN mapping stage, the ingress subdomain X (e.g., equal to 10 in this example) can be temporarily stored as metadata (see operations of block 74) that is conveyed along with the data packet as it traverses the packet processing pipeline. This metadata is sometimes referred to as forwarding metadata. The forwarding domain of the data packet (e.g., the private VLAN domain information equal to 1000 in this example) can also optionally be stored as part of the forwarding metadata that is conveyed along with the data packet.

Subsequent to the VLAN mapping stage 60, the data packet can be conveyed through intermediate stages 62. The intermediate packet processing stages 62 can include processes not necessarily related to private VLAN operation such as a tunneling stage for creating a virtual tunnel between two endpoints, a termination stage for selectively removing or extracting a packet header or other portions of a data packet, a classification stage for ensuring quality of service (QoS) policies, encryption/decryption stage(s) for encrypting or decrypting packet contents to ensure data confidentiality and integrity, and/or other intermediate packet processing pipeline stages. During the intermediate stages 62, the forwarding domain of the data packet remains as the private VLAN domain as set during the VLAN mapping stage 60 (e.g., the packet is processed with forwarding domain set to 1000). In general, the intermediate stages 62 can include only one stage, two or more stages, three or more stages, four or more stages, five to ten stages, or more than ten stages.

Subsequent to the intermediate stages 62, the data packet can be conveyed to learning and forwarding stage 64. At least in the initial parts of stage 64, the forwarding domain of the data packet remains as the private VLAN domain as set during the VLAN mapping stage 60 (e.g., the packet continues to be processed with the forwarding domain set to 1000). The learning and forwarding stage 64 can include a learning lookup operation such as learning lookup 70 and a separate forwarding lookup operation such as forwarding lookup 72. During the learning lookup 70, the current forwarding domain (which is presently set equal to the private VLAN domain) and the source MAC address of the data packet can be used as keys to identify a corresponding ingress (source) port from which the data packet arrived. If no source port or a new source port is identified, then this association can be learned.

The learning of the source port can occur as follows. Consider an example in which Ethernet-1 is the source port and where the primary VLAN subdomain and the secondary VLAN subdomain of Ethernet-1 is equal to exemplary values of 100 and 10, respectively. There can be another port Ethernet-2 having the same primary VLAN subdomain and secondary VLAN subdomain of 100 and 10, respectively. Here, the private VLAN domain for the two secondary VLANs is equal to 1000.

The first time a data packet is received on Ethernet-1, a lookup operation using a source MAC address (referred to herein as “SMAC”) and the private VLAN domain of 1000 can be performed in the learning stage to see if the network device has already learned of this particular combination of (SMAC, 1000). This will occur if no source port has yet been identified, which will be true assuming this is the first time a packet is received with (SMAC, 1000). In this situation, the source MAC learning will occur and will learn that (SMAC, 1000) maps to Ethernet-1.

Consider a scenario where the SMAC moves to Ethernet-2. In this case, when a data packet is received on Ethernet-2 with SMAC, another lookup operation with (SMAC, 1000) will be performed in the learning stage to check whether the network device has already learned (SMAC, 1000). An entry will be found as (SMAC, 1000) has already been learned for Ethernet-1. However, since the source port has now changed to Ethernet-2, (SMAC, 1000) will now be map to Ethernet-2.

During the forwarding lookup 72, the current forwarding domain (which is presently set to the private VLAN domain) and the destination MAC address of the data packet can be used as keys to a forwarding table to identify a corresponding egress (destination) port from which the data packet should exit. The forwarding table is sometimes referred to as a forwarding information base (FIB). The learning lookup operation 70 can also optionally look up the same table as forwarding lookup operation 72 (e.g., the private VLAN domain of 1000 and the source MAC address can be used as keys to the same forwarding information base). The learning lookup operation 70 can occur before, after, or in parallel (simultaneously) with the forwarding lookup operation 72. Here, the result of the forwarding lookup 72 might return an egress port of Ethernet-2 as an example.

By setting the forwarding domain of the packet equal to the private VLAN domain of the private VLAN, the learning and forwarding lookup operations for the primary and corresponding secondary VLANs can all occur in the same forwarding domain, thus satisfying the first (1) private VLAN requirement listed above. After the learning and forwarding lookups, the forwarding domain of the packet can be reset back to the ingress subdomain X towards the end of the learning and forwarding stage 64 (e.g., the forwarding domain is reset back to 10 using the metadata). The ingress subdomain X associated with a primary or secondary VLAN can be retrieved or extracted from the metadata that is carried along with the data packet through the packet processing pipeline, as shown by dotted path 76.

Subsequent to the learning and forwarding stage 64, the data packet can be conveyed to VLAN filter stage 66 via one of more intermediate stages 65. Since the forwarding domain of the data packet has been reset back to the ingress subdomain X by the end of the learning and forwarding stage 64, stage 66 filters the data packet based on the ingress subdomain X (e.g., the packet can be processed with the forwarding domain reset back to 10). VLAN filtering stage 66 can control network traffic based on VLAN membership, which helps to prevent unauthorized access to network resources and increase network security. VLAN filtering stage 66 can perform filtering based on VLAN membership across one or more switch ports, allowing or blocking network traffic based on the filter policies. For example, filtering on ports of an isolated VLAN (e.g., VLAN 36-3 of FIG. 2) should drop all traffic other than those coming from ports of the primary VLAN. As another example, filtering on ports of a community VLAN (e.g., VLAN 36-1 or 36-2 of FIG. 2) should drop all traffic other than those coming from ports/devices within the same community VLAN or from ports of the primary VLAN. Performing VLAN filtering operations based on the ingress subdomain X of the primary or secondary VLAN thus satisfies the second (2) private VLAN requirement listed above.

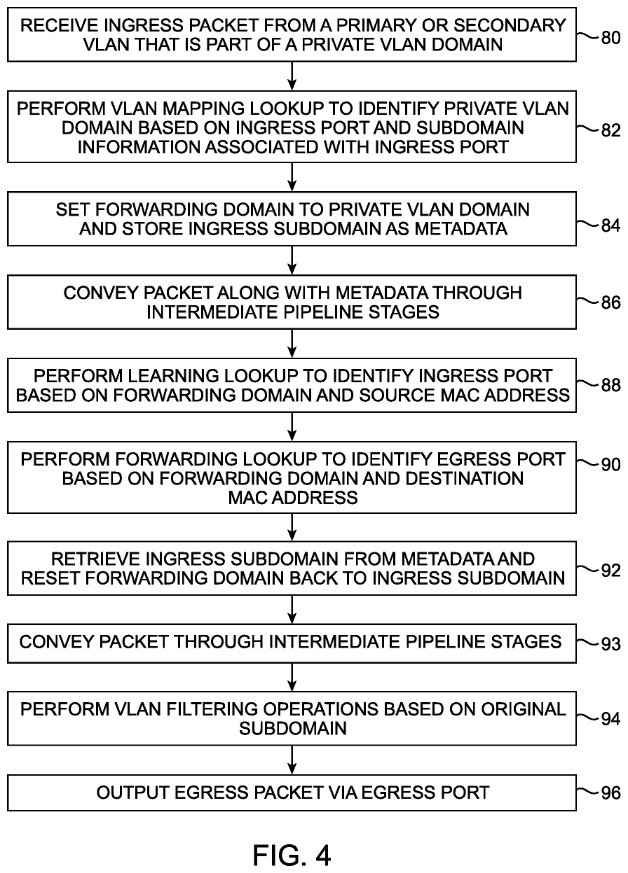

FIG. 4 is a flow chart of illustrative steps for operating the packet processing pipeline shown in FIG. 3 in accordance with some embodiments. During the operations of block 80, the packet processing pipeline can receive an ingress data packet from a primary or secondary VLAN that is part of a private VLAN domain. For instance, the ingress packet can be received at a particular ingress port such as a promiscuous port of the primary VLAN, at a community port of a secondary community VLAN, or at an isolated port of a secondary isolated VLAN.

During the operations of block 82, the VLAN mapping stage can perform a VLAN mapping lookup to identify a corresponding private VLAN domain based on the ingress port at which the data packet arrived and subdomain information associated with the ingress port. The subdomain information can represent an ingress subdomain that is associated with a primary or secondary VLAN in the private VLAN domain. During the operations of block 84, a forwarding domain of the data packet can be set to the private VLAN domain identified during block 82, and the ingress subdomain (and optionally the private VLAN domain) can be stored as metadata that travels along with the data packet through the packet processing pipeline. The forwarding domain can be defined herein as a domain in which the learning and forwarding lookups occur in the packet processing pipeline. After the VLAN mapping stage, the data packet and the associated metadata can be conveyed together through the intermediate pipeline stages 62 (see operations of block 86).

The data packet can traverse the intermediate pipeline stages and arrive at the learning and forwarding stage. During the operations of block 88, the learning stage can perform a learning lookup to identify an ingress (source) port that is associated with the forwarding domain (which is currently set equal to the private VLAN domain) and the source MAC address of the data packet. If no source port or a new source port is identified, then this association can be learned. During the operations of block 90, the forwarding stage can perform a forwarding lookup to identify an egress (destination) port that is associated with the forwarding domain (which is currently set equal to the private VLAN domain) and the destination MAC address of the data packet. For example, the current forwarding domain and the destination MAC address of the data packet can be used as keys to a forwarding table to identify the destination port from which the data packet should exit. The forwarding table is sometimes referred to as a forwarding information base (FIB). Although the flow of FIG. 4 shows block 90 as occurring after block 88, the forwarding lookup operations of block 90 can occur before or in parallel (simultaneously) with the learning lookup operations of block 88.

At the end of the forwarding stage during the operations of block 92, the forwarding metadata can be extracted to retrieve the ingress subdomain. The forwarding domain of the data packet can then be reset back to the ingress subdomain using the retrieved information. During the operations of block 93, the data packet can be conveyed through one or more additional intermediate (ingress or egress) stages 65. During the operations of block 94, the VLAN filtering stage can perform VLAN filtering operations based on the original subdomain of the data packet (e.g., based on the ingress subdomain associated with a primary or secondary VLAN). For example, VLAN filtering on ports of an isolated VLAN should drop all network traffic other than those coming from ports of the primary VLAN. During the operations of block 96, the data packet may emerge as an egress packet that is output from the egress port identified in block 90.

The operations of FIG. 4 are merely illustrative. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

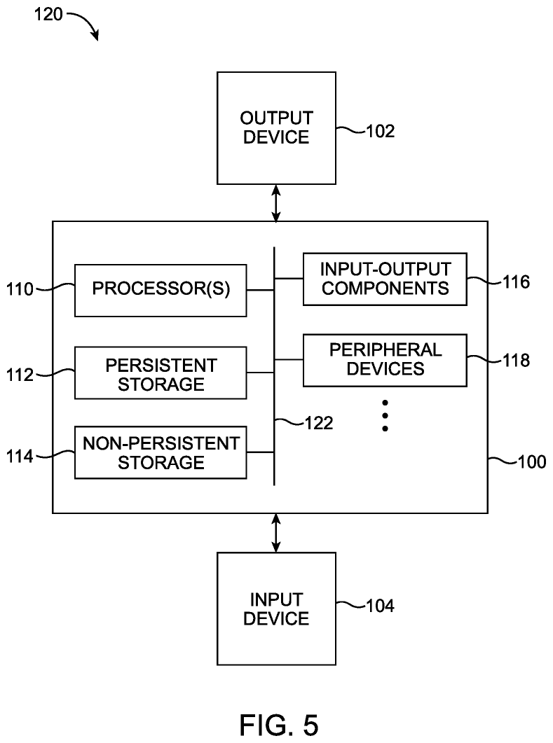

The foregoing embodiments may be made part of a larger system. FIG. 5 shows a system such as data processing system 120. Data processing system 120 may include a network device 100 optionally coupled to an input device 104 and/or an output device 102. Network device 100 may represent a network device 10 described in connection with the embodiments of FIGS. 1-4. Network device 100 may include one or more processors 110 (e.g., CPU 12 of FIG. 1), storage circuitry such as persistent storage 112 (e.g., flash memory or other electrically-programmable read-only memory configured to form a solid-state drive, a hard disk drive, etc.), non-persistent storage 114 (e.g., volatile memory such as static or dynamic random-access memory, cache memory, etc.), or any suitable type of computer-readable media for storing data, software, program code, or instructions, input-output components 116 (e.g., communication interface components such as a Bluetooth® interface, a Wi-Fi® interface, an Ethernet interface, an optical interface, and/or other networking interfaces for connecting device 100 to the Internet, a local area network, a wide area network, a mobile network, other types of networks, and/or to another network device), peripheral devices 118, and/or other electronic components. These components can be coupled together via a system bus 122.

As an example, network device 100 can be part of a host device that is coupled to one or more output devices 102 and/or to one or more input device 104. Input device(s) 104 may include one or more touchscreens, keyboards, mice, microphones, touchpads, electronic pens, joysticks, buttons, sensors, or any other type of input devices. Output device(s) 106 may include one or more displays, printers, speakers, status indicators, external storage, or any other type of output devices.

System 120 may be part of a digital system or a hybrid system that includes both digital and analog subsystems. System 120 may be used in a wide variety of applications as part of a larger computing system, which may include but is not limited to: a datacenter, a financial system, an e-commerce system, a web hosting system, a social media system, a healthcare/hospital system, a computer networking system, a data networking system, a digital signal processing system, an energy/utility management system, an industrial automation system, a supply chain management system, a customer relationship management system, a graphics processing system, a video processing system, a computer vision processing system, a cellular base station, a virtual reality or augmented reality system, a network functions virtualization platform, an artificial neural network, an autonomous driving system, a combination of at least some of these systems, and/or other suitable types of computing systems.

The methods and operations described above in connection with FIGS. 1-5 may be performed by the components of a network device using software, firmware, and/or hardware (e.g., dedicated circuitry or hardware). Software code for performing these operations may be stored on non-transitory computer readable storage media (e.g., tangible computer readable storage media) stored on one or more of the components of the network device. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device (e.g., processor 12 of FIG. 1, processor 110 of FIG. 5, etc.).

The foregoing is merely illustrative and various modifications can be made to the described embodiments. The foregoing embodiments may be implemented individually or in any combination.

What is claimed is:

1. A method of operating a network device, comprising:
receiving a packet via an ingress port of the network device;
performing a virtual local area network (VLAN) mapping lookup to identify a private VLAN domain based on the ingress port and an ingress subdomain associated with a primary VLAN or a secondary VLAN in the private VLAN domain; and
setting a forwarding domain of the packet to the private VLAN domain identified by the VLAN mapping lookup.

2. The method of claim 1, further comprising:
storing the ingress subdomain as metadata that is associated with the packet.

3. The method of claim 2, further comprising:
storing the private VLAN domain as part of the metadata.

4. The method of claim 2, wherein setting the forwarding domain of the packet to the private VLAN domain comprises modifying the forwarding domain of the packet from the ingress subdomain to the private VLAN domain identified by the VLAN mapping lookup.

5. The method of claim 2, further comprising:
performing a learning lookup to identify the ingress port associated with the forwarding domain and a source media access control (MAC) address in the packet.

6. The method of claim 5, further comprising:
performing a forwarding lookup to identify an egress port associated with the forwarding domain and a destination media access control (MAC) address in the packet.

7. The method of claim 6, further comprising:
retrieving the stored ingress subdomain from the metadata; and
after performing the learning lookup and the forwarding lookup, setting the forwarding domain of the packet to the retrieved ingress subdomain.

8. The method of claim 7, further comprising:
performing VLAN filtering after the forwarding domain of the packet has been set to the retrieved ingress subdomain.

9. The method of claim 6, wherein the forwarding lookup is performed before or in parallel with the learning lookup.

10. The method of claim 5, further comprising:
conveying the packet through one or more intermediate packet processing pipeline stages after performing the VLAN mapping lookup and before performing the learning lookup.

11. A method of operating a private virtual local area network (VLAN), comprising:
receiving a data packet at an ingress port;
performing a VLAN mapping lookup operation to identify a private VLAN domain of the private VLAN based on the ingress port and an ingress subdomain associated with a primary VLAN or a secondary VLAN in the private VLAN; and
performing learning and forwarding lookup operations using the private VLAN domain.

12. The method of claim 11, further comprising:
setting a forwarding domain of the data packet from the ingress subdomain to the private VLAN domain.

13. The method of claim 12, further comprising:
storing the ingress subdomain as metadata.

14. The method of claim 13, further comprising:
extracting the ingress subdomain from the metadata; and
after performing the learning and forwarding lookup operations, setting the forwarding domain from the private VLAN domain back to the extracted ingress subdomain.

15. The method of claim 14, further comprising:
performing the learning lookup operation to identify the ingress port based on the private VLAN domain and a source address of the data packet; and
performing the forwarding lookup operation to identify an egress port based on the private VLAN domain and a destination address of the data packet.

16. The method of claim 14, further comprising:
after setting the forwarding domain from the private VLAN domain back to the extracted ingress subdomain, performing a VLAN filtering operation.

17. A system comprising:
an ingress port configured to receive a data packet;
a virtual local area network (VLAN) mapping stage configured to perform a VLAN mapping lookup to identify a private VLAN domain using an ingress subdomain of a primary VLAN or a secondary VLAN in the private VLAN domain; and
a learning and forwarding stage configured to perform learning and forwarding lookups using the private VLAN domain.

18. The system of claim 17, further comprising:
a VLAN filtering stage configured to filter the data packet based on the ingress subdomain.

19. The system of claim 17, wherein during the VLAN mapping stage, a forwarding domain of the data packet is changed from the ingress subdomain to the private VLAN domain, and the ingress subdomain is stored as metadata associated with the data packet.

20. The system of claim 17, wherein the learning and forwarding stage is further configured to:
perform the learning lookup by using the private VLAN domain and a source media access control (MAC) address of the data packet as keys to identify the ingress port; and
perform the forwarding lookup by using the private VLAN domain and a destination MAC address of the data packet as keys to identify a corresponding egress port for the data packet.
